(19) United States
(12) Patent Application Publication
(10) Pub. No.: US 2017/0215640 A1
(43) Pub. Date: Aug. 3, 2017

(54) Food Reheating Assembly

(71) Applicant: Andrew Wright, Jamaica, NY (US)

(72) Inventor: Andrew Wright, Jamaica, NY (US)

(21) Appl. No.: 15/014,432

(22) Filed: Feb. 3, 2016

(51) Int. Cl. A47J 37/06; F24C 15/16; F24C 7/06

(52) U.S. Cl. CPC A47J 37/0658; F24C 7/067; F24C 15/16

(57) ABSTRACT

A food reheating assembly for includes an oven that may have a slice of pizza positioned therein. A door is hingedly coupled to the oven. The door is positionable in an open position and a closed position. A heating element is positioned within the oven and the heating element heats the slice of pizza. A control is coupled to the front side and the control may be manipulated. The control is electrically coupled to the heating element such that the control turns the heating element on and off.

### BACKGROUND OF THE DISCLOSURE

### Field of the Disclosure

The disclosure relates to reheating devices and more particularly pertains to a new reheating device for evenly reheating a slice of pizza.

### SUMMARY OF THE DISCLOSURE

An embodiment of the disclosure meets the needs presented above by generally comprising an oven that may have a slice of pizza positioned therein. A door is hingedly coupled to the oven. The door is positionable in an open position and a closed position. A heating element is positioned within the oven and the heating element heats the slice of pizza. A control is coupled to the front side and the control may be manipulated. The control is electrically coupled to the heating element such that the control turns the heating element on and off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a food reheating assembly according to an embodiment of the disclosure.

FIG. 2 is a perspective view of an embodiment of the disclosure.

FIG. 3 is a cross sectional view taken along line 3-3 of FIG. 1 of an embodiment of the disclosure.

FIG. 4 is a front view of an embodiment of the disclosure.

FIG. 5 is a bottom phantom view of an embodiment of the disclosure.

### DESCRIPTION OF THE PREFERRED EMBODIMENT

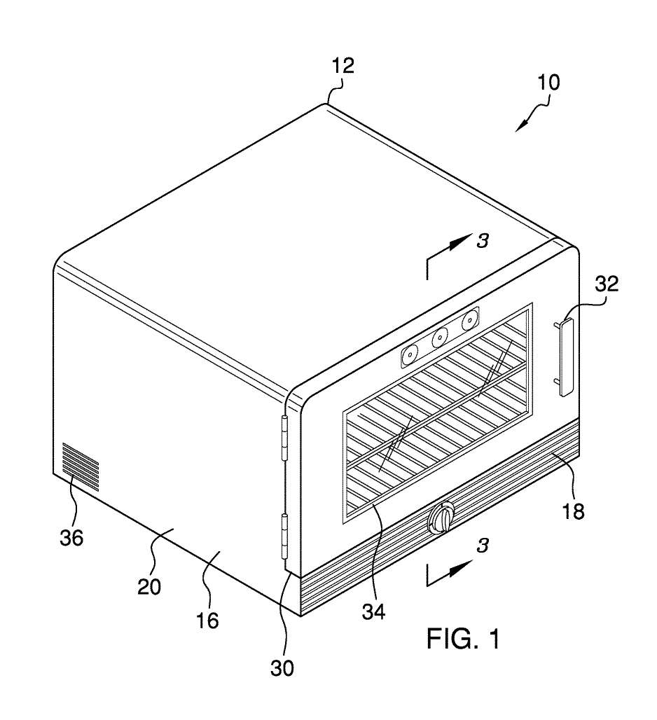

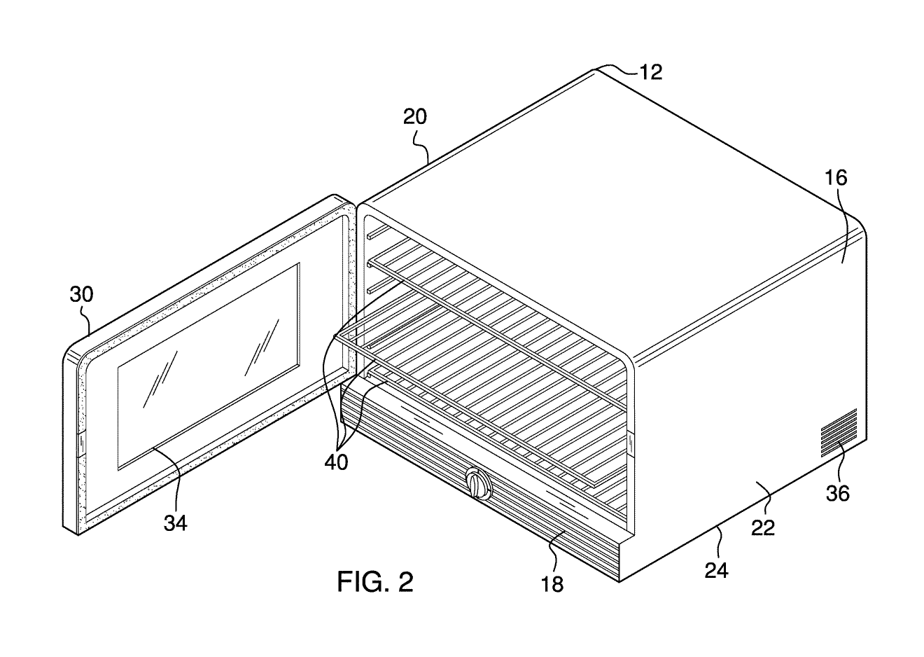

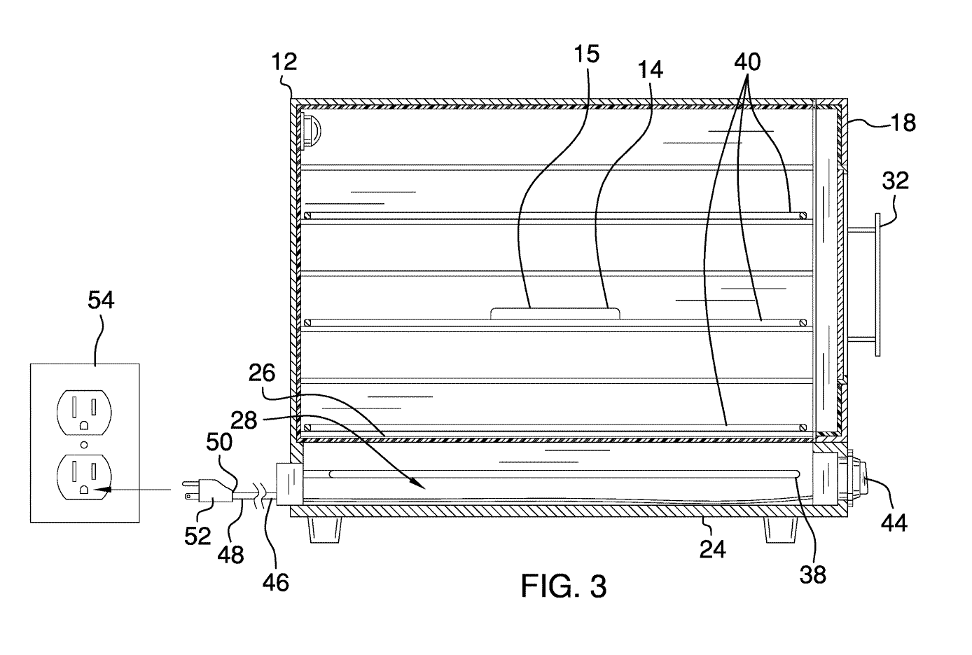

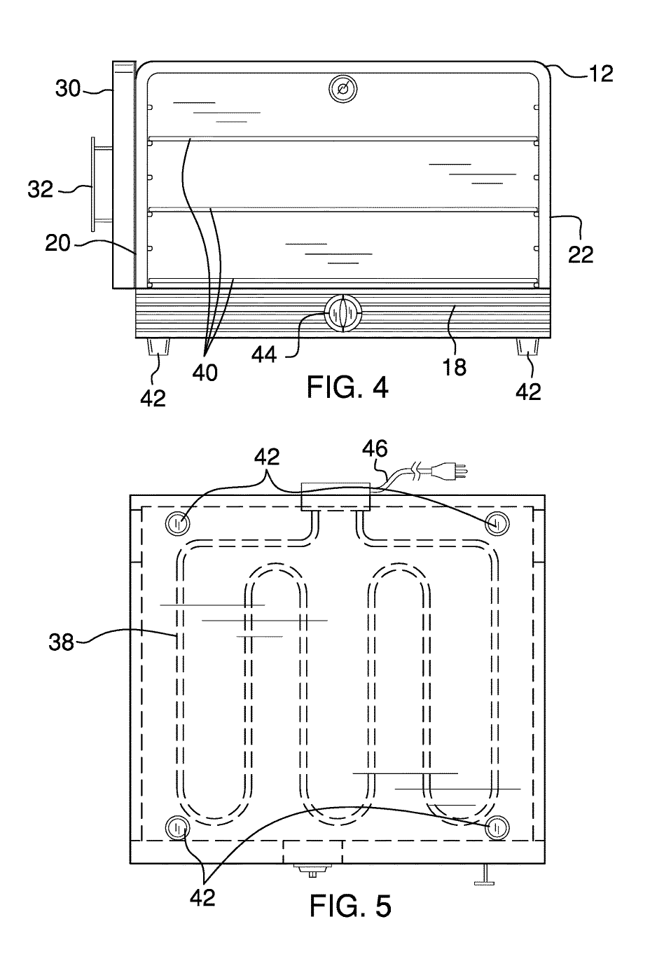

With reference now to the drawings, and in particular to FIGS. 1 through 5 thereof, a new reheating device embodying the principles and concepts of an embodiment of the disclosure and generally designated by the reference numeral 10 will be described.

As best illustrated in FIGS. 1 through 5, the food reheating assembly 10 generally comprises an oven 12 that may have a food item 14 positioned therein. The food item 14 may comprise a slice of pizza 15. Additionally, the food item 14 may comprise any pre-cooked food item to be reheated. The oven 12 has an outer wall 16, and the outer wall 16 has a front side 18, a first lateral side 20, a second lateral side 22 and a bottom side 24. The front side 18 is substantially open to access an interior of the oven 12. An interior wall 26 is spaced from the bottom side 24 to define a heating space 28 between the interior wall 26 and the bottom side 24.

A door 30 is hingedly coupled to the oven 12 and the door 30 is positioned on the front side 18. The door 30 is positionable in an open position to access the interior of the oven 12. The door 30 is positionable in a closed position to close the oven 12. A handle 32 is coupled to the door 30 and the handle 32 may be gripped. The door 30 includes a window 34 extending through the door 30. Each of the first lateral side 20 and the second lateral side 22 has a vent 36. The vent 36 corresponding to each of the first lateral side 20 and the second lateral side 22 facilitate air to pass into and out of the oven 12.

A heating element 38 is positioned within the oven 12. The heating element 38 may heat the slice of pizza 15. The heating element 38 is positioned within the heating space 28 and the heating element 38 is in thermal communication with the interior wall 26. The heating element 38 generates heat when the heating element 38 is turned on.

The heating element 38 heats the interior wall 26 when the heating element 38 is turned on. Thus, the interior wall 26 heats the slice of pizza 15 thereby inhibiting the heating element 38 from burning the slice of pizza 15. The interior wall 26 may be comprised of a thermally conductive material. The heating element 38 may comprise an electric heating coil or the like. The heating element 38 may have an operational temperature ranging between 180° Fahrenheit and 225° Fahrenheit.

A plurality of racks 40 is provided and each of the racks 40 is slidably positioned within the oven 12. The racks 40 are spaced apart from each other. A selected one of the racks 40 may support the slice of pizza 15. Thus, the slice of pizza 15 may be spaced a selected distance from the interior wall 26.

A plurality of feet 42 is provided. Each of the feet 42 is coupled to the bottom side 24 of the oven 12. Each of the feet 42 is positioned adjacent to an associated one of four corners of the bottom side 24. The feet 42 may support the oven 12 above a support surface.

A control 44 is coupled to the front side 18 and the control 44 may be manipulated. The control 44 is electrically coupled to the heating element 38. Thus, the control 44 turns the heating element 38 on and off. The control 44 may comprise an electronic timer or the like. Thus, the electronic timer may turn the heating element 38 off after a selected duration of time.

A power supply 46 is coupled to the oven 12 and the power supply 46 is electrically coupled to the heating element 38. The power supply 46 comprises a cord 48 extending outwardly from the outer wall 16. The cord 48 has a distal end 50 with respect to the outer wall 16 and a plug 52 is electrically coupled to the distal end 50. The plug 52 may be electrically coupled to a power source 54. The power source 54 may comprise an electrical outlet or the like.

In use, door 30 is positioned in the open position and the slice of pizza 15 is placed on a selected rack 40. The door 30 is positioned in the closed position and the control 44 is manipulated. The control 44 is set to turn the heating element 38 on for the selected duration of time. The slice of pizza 15 is removed from the oven 12 when the control 44 turns the heating element 38 off.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A food reheating assembly comprising:
an oven being configured to have a slice of pizza positioned therein;
a door being hingedly coupled to said oven, said door being positionable in an open position to access said interior of said oven, said door being positionable in a closed position having said door closing said oven;
a heating element being positioned within said oven wherein said heating element is configured to heat the slice of pizza;
a control being coupled to said front side wherein said control is configured to be manipulated, said control being electrically coupled to said heating element such that said control turns said heating element on and off.

2. The assembly according to claim 1, wherein said oven has an outer wall, said outer wall having a front side and a bottom side, said front side being substantially open to access an interior of said oven, said oven having an interior wall being spaced from said bottom side to define a heating space between said interior wall and said bottom side.

3. The assembly according to claim 2, wherein said heating element is positioned within said heating space such that said heating element is in thermal communication with said interior wall, said heating element generating heat when said heating element is turned on, said heating element heating said interior wall when said heating element is turned on wherein said interior wall is configured to heat to the slice of pizza thereby inhibiting said heating element from burning the slice of pizza.

4. The assembly according to claim 2, further comprising a plurality of racks, each of said racks being slidably positioned within said oven, said racks being spaced apart from each other, a selected one of said racks being configured to support the slice of pizza thereby facilitating the slice of pizza to be spaced a selected distance from said interior wall.

5. The assembly according to claim 2, wherein a power supply being coupled to said oven, said power supply being electrically coupled to said heating element, said power supply comprising a cord extending outwardly from said outer wall, said cord having a distal end with respect to said outer wall, said distal end having a plug being electrically coupled thereto, said plug being configured to be electrically coupled to a power source.

6. A food reheating assembly comprising:
an oven being configured to have a slice of pizza positioned therein, said oven having an outer wall, said outer wall having a front side and a bottom side, said front side being substantially open to access an interior of said oven, said oven having an interior wall being spaced from said bottom side to define a heating space between said interior wall and said bottom side;
a door being hingedly coupled to said oven, said door being positioned on said front side, said door being positionable in an open position to access said interior of said oven, said door being positionable in a closed position having said door closing said oven;
a heating element being positioned within said oven wherein said heating element is configured to heat the slice of pizza, said heating element being positioned within said heating space such that said heating element is in thermal communication with said interior wall, said heating element generating heat when said heating element is turned on, said heating element heating said interior wall when said heating element is turned on wherein said interior wall is configured to heat to the slice of pizza thereby inhibiting said heating element from burning the slice of pizza;
a plurality of racks, each of said racks being slidably positioned within said oven, said racks being spaced apart from each other, a selected one of said racks being configured to support the slice of pizza thereby facilitating the slice of pizza to be spaced a selected distance from said interior wall;
a control being coupled to said front side wherein said control is configured to be manipulated, said control being electrically coupled to said heating element such that said control turns said heating element on and off; and
a power supply being coupled to said oven, said power supply being electrically coupled to said heating element, said power supply comprising a cord extending outwardly from said outer wall, said cord having a distal end with respect to said outer wall, said distal end having a plug being electrically coupled thereto, said plug being configured to be electrically coupled to a power source.
